(19) United States
(12) Patent Application Publication
(10) Pub. No.: US 2007/0161299 A1
(43) Pub. Date: Jul. 12, 2007

(54) Structure for firmly combining cables with clamping element

(76) Inventor: Kuo-Hsiung Chen, Taoyuan Hsien (TW)

Correspondence Address: LIN & ASSOCIATES INTELLECTUAL PROPERTY, P.O. BOX 2339, SARATOGA, CA, 95070-0339, US

(21) Appl. No.: 11/327,269

(22) Filed: Jan. 7, 2006

(51) Int. Cl. H01R 4/30

(52) U.S. Cl. 439/801

(57) ABSTRACT

A structure for firmly combining cables with a clamping element is disclosed. The clamping element is of tubular-like shape and has a circular, C-shaped, 6-shaped or H-shaped section, and the improvement includes the clamping element having locking ribs on an outer surface thereof or locking grooves on an inner surface thereof. When the clamping element is used to crimp cables, it can be firmly combined with the cables due to the locking ribs or locking grooves, thereby being able to reduce electrical resistance and temperature rise, and to enhance tensile strength and quality in connecting region of the cables.

### BACKGROUND OF THE INVENTION

1. Field of the Invention

The present invention relates generally to an improved structure for firmly combining cables with a clamping element, which is suitable to connect cables or used as a terminal.

2. The Prior Arts

Clamping elements, which are generally categorized into a tension type and a non-tension type, have been widely used in various fields. For example, the clamping elements can be used to connect cables or used as a tubular terminal provided on an end of a cable.

Now, a screw-locked-type clamping element having collocating grooves is most frequently used. Such clamping element comprises two cable grooves provided on a thick aluminum plate and at least two holes for bolts. By using at least two nuts to fasten the bolts, the connection between cables can be achieved. However, since the connecting area between the clamping element and the cables is small and thus the electrical resistance in the connecting area is larger, resulting in that the electric performance is unstable, and the connecting area is liable to be burned down. Further, it is dangerous and difficult to work in an electrified situation. That may cause an operator to get an electric shock.

In order to overcome the drawbacks of conventional clamping elements including collocating grooves, C-shaped, 6-shaped and H-shaped clamping elements are thus developed. Such kinds of clamping elements mainly comprise a body having cable grooves, or may be integrally formed with a body having cable grooves, and caps. In practical use, the operator can carry out the crimping with a hydraulic clamp. Further, the electrical resistance in the connecting area is smaller, and the electric performance is more stable. Thus, it is easier to operate and is not likely for an operator to get an electric shock. However, such clamping elements still have the following drawbacks.

(1) Since the cap of the existing H-shaped clamping element lacks locking ribs or locking grooves, when crimping cables, the tightness in connecting region is insufficient, causing the invasion and attachment of humidity and dust. The tensile strength, electrical resistance and temperature rise in the connecting region are less stable. Further, it is liable to be corroded and thus burned down.

(2) Since the cap of the existing H-shaped clamping element lacks locking ribs or locking grooves, when crimping lower limit cables, that means, a smallest cable is connected to another smallest cable, the cap cannot be inserted into the cable groove deep enough and cannot be sufficiently filled into the gap in the cable groove. As a result, the clamped cables have smaller tensile strength, larger electrical resistance, and higher temperature rise in the connecting region, probably causing the electricity lines to break down.

(3) When crimping upper limit cables, the cap of the existing H-shaped clamping element is exactly connected to a distal end of the clamping element, which forms two weak seams. As a result, the seams are liable to be corroded and peeled off.

(4) Since the cap of the existing H-shaped clamping element lacks locking grooves, if crimping the clamping element more than once, the cap will be broken at the crimping position at the first time. As a result, the crimping quality of the cables will be seriously influenced.

(5) Since the cap of the existing H-shaped clamping element lacks locking ribs or locking grooves, before crimping, the cap has to be bent upwardly more than 45 degrees to facilitate insertion of the cable. Because no locking rib is provided, if the upward bending angle exceeds 45 degrees, it will cause the cap to be broken and peeled off. As a result, the clamping element with a broken cap fails to be used in crimping, resulting in the waste of time and material.

(6) The situation of the above item No. (5) is especially easy to occur in the electrified operations. Since the operator has to wear rubber gloves each covering with a protecting leather glove, his fingers become less flexible so as to even snap the cap. As a result, some unskilled operators often result in the waste of time and material.

(7) In existing 6-shaped and C-shaped clamping elements, after small-diameter cables are connected to another small-diameter cables with the same size by crimping, since the gap in the cable groove cannot be sufficiently filled, its tensile strength, electrical resistance and temperature rise in the connecting region are difficult to meet with the international standards.

(8) In existing 6-shaped and C-shaped clamping elements, since the gap in the cable groove cannot be sufficiently filled after crimping, the crimped cables have smaller tensile strength, larger electrical resistance and higher temperature rise. As a result, it is very liable to cause the cables to be loosened from the clamping element and even burned down. Further, the breakdown in the electricity lines may be also happened.

(9) In existing 6-shaped and C-shaped clamping elements, since the gap in the cable groove cannot be sufficiently filled after crimping, the humidity and dust may invade the gap. As a result, the clamping element and cables may be corroded, probably causing the electricity lines to be burned down.

(10) In existing 6-shaped and C-shaped clamping elements, when crimping, both ends of the cable grooves of the clamping element cannot firmly combined with the cables and then be bent into the clamping element. As a result, after crimping, the cable grooves and the cables become flattened and thus cannot meet with to the requirements of the crimping.

(11) In existing 6-shaped and C-shaped clamping elements, according to the above, the crimped clamping element, the cable grooves and the cables become flattened, such that the cables are easy to be loosened and the strands of cables are liable to spread. As a result, the protection may be reduced so as to produce the corrosion and burning of the cables, causing the breakage of the electricity lines.

(12) In existing 6-shaped and C-shaped clamping elements, the length of the clamping element is enlarged to increase its tensile strength. Therefore, if the times of crimping increase, since the crimped clamping element is curved, the insulating rubber tube cannot be inserted. If the operator forces the rubber tube to be inserted into the curved electrified portion, the rubber tube may be exposed outside, causing difficulty in electrified operation and potential risk of getting an electric shock.

(13) In existing 6-shaped and C-shaped clamping elements, after crimping, since the clamping element is curved, the curved portion of the clamping element may be broken by expansion when hot and shrinkage when cold due to the temperature differences between day and night and the load differences between the peak time and off-peak time. As a result, the connected cables may be loosened or broken, causing the breakage of electricity and in turn the decrease in profit from supplying electricity.

(14) In existing 6-shaped and C-shaped clamping elements, after crimping, the cable grooves and cables become flattened, such that the cables may be loosened, corroded and broken. Thus, the electric system may break down and harm to the machines or tools of the user. As a result, the user and the electricity company will suffer from a great loss, and thus they may dispute on the compensation.

(15) Since the existing clamping element having a circular terminal is not provided with locking ribs or locking grooves, and further in the crimping of single cable with individual specification, the gap between the cable groove and the cable is very small, causing operational difficulty. Especially in electrified operation, the operation is more difficult and the operator has to prepare a lot of different size cables, causing the increase in cost.

(16) Since the existing circular tension-type clamping element is not provided with locking ribs or locking grooves, and further in the crimping of two cables having the same diameter, the gap between the cable groove and the cable is very small, causing operational difficulty. Especially in electrified operation, the operation is more difficult and the operator has to prepare a lot of different size cables, causing the increase in cost.

### SUMMARY OF THE INVENTION

An objective of the present invention is to provide a structure for firmly combining the cables with the clamping element to overcome the above drawbacks, in which the shape and surface structure of cable grooves of the clamping element are improved to reduce compression stress on the inner surface thereof. Thus, it has a better compactness, greater tensile strength, and smaller electrical resistance and temperature rise.

In order to achieve the above objects, a clamping element in accordance with the present invention has a circular, C-shaped, 6-shaped or H-shaped section, wherein locking grooves or locking ribs are provided on an outer or inner surface of the clamping element. When the clamping element of the present invention is used to crimp cables, the locking grooves or locking ribs provided on its outside or inner surface can facilitate to tightly combine with the cables. As a result, the electrical resistance and temperature rise can be reduced, and the tensile strength and quality of the cables can be improved.

According to the above, the improvements of the present invention are described as follows:

(1) In accordance with the present invention, the structure for firmly combining cables with a clamping element is provided with locking grooves or locking ribs in an outer or inner surface thereof. The locking groves or ribs can produce the effects of stress balance and engagement. When crimping, the locking grooves can be helpful to reduce the tension stress and compression stress on the surface of the cable groove, and engage its inner surface with the cables. The locking ribs are helpful to enhance the strength of the outer surface of the cable groove and the engagement between the inner surface and the cables. As a result, the cable groove can effectively and compactly attached with the cable. After crimping, the cable groove of the clamping element and the cables keep having a near circular section. Thus, the clamping element and the crimped cables are straight.

(2) Since the clamping element of the present invention is provided with locking grooves or locking ribs, there is no gap in the cable grooves after it is crimped with the cables. So, the invasion of humidity and dust into the cables can be avoided. Further, the cables will not be loosened, corroded or broken, and thus the electricity lines will not shut down.

(3) Since the clamping element of the present invention is provided with locking grooves or locking ribs, no matter a long or short clamping element is inserted into the cable, after crimping, the clamping element and the cable are still straight without bending or deformation. As a result, the present invention can meet with the requirements of the crimping.

(4) Since the clamping element of the present invention is provided with locking grooves or locking ribs, after crimping, the clamping element will not be bent or deformed. During the electrified operation, an insulating rubber tube can be easily inserted without any conductor exposure outside. As a result, in the electrified operation, the difficulty in working and the potential risk of getting an electric shock can be solved.

(5) Since the clamping element of the present invention is provided with locking grooves or locking ribs, after crimping the cable, the clamping element will not be bent or deformed. As a result, it will not be loosened, corroded or broken by expansion when hot and shrinkage when cold due to the temperature differences between day and night and the load differences between the peak time and off-peak time.

(6) Since the clamping element of the present invention is provided with locking grooves or locking ribs, single specification clamping element can be used to crimp different size cables. Further, the gap between the cable groove and the cables is larger, which brings convenience in working in the electrified operation. In sum, operators can use fewer specifications of the clamping elements to crimp various cables with different size, thereby being able to reduce material preparation cost.

(7) When the clamping element of the present invention is used to crimp the cables, it has multiple advantages, such as operation easy, durableness, compactness, energy-saving, operation safe, reduction of accidents and electricity lose, and the increase in electricity supply reliability and electricity supply profit.

(8) The present invention can be used in high-volt and low-volt power transmission and distribution lines to prevent the breakdown of electricity lines. In addition. the present invention can also be used in indoor lines to prevent fire accidents due to the spark caused by the joint loose.

The present invention will become more obvious from the following description when taken in connection with the accompanying drawings, which show, for purposes of illustration only, preferred embodiments in accordance with the present invention. In the drawings:

### BRIEF DESCRIPTION OF THE DRAWINGS

FIG. 1 is a perspective view of a circular clamping element in accordance with the present invention;

FIG. 2 is a plan view of a circular clamping element in accordance with the present invention;

FIG. 3 is a perspective view of the circular clamping element of FIG. 1, which is combined with cables;

FIG. 3A is a cross-sectional view showing that the circular clamping element of FIG. 1 is combined with cables;

FIG. 4 is a perspective view of another circular clamping element in accordance with the present invention;

FIG. 5 is a perspective view of another circular clamping element in accordance with the present invention;

FIG. 6 is a view showing that the circular clamping element of FIG. 4 is combined with cables;

FIG. 7 is a perspective view of a C-shaped clamping element in accordance with the present invention;

FIG. 8 is a plan view of another C-shaped clamping element in accordance with the present invention;

FIG. 9 is a perspective view showing that the C-shaped clamping element of FIG. 7 is combined with cables;

FIG. 10 is a perspective view of a 6-shaped clamping element in accordance with the present invention;

FIG. 11 is a plan view of another 6-shaped clamping element in accordance with the present invention;

FIG. 12 is a perspective view showing that the 6-shaped clamping element of FIG. 10 is combined with cables;

FIG. 13 is a perspective view of a H-shaped clamping element in accordance with the present invention;

FIG. 14 is a plan view of another H-shaped clamping element in accordance with the present invention; and

FIG. 15 is a perspective view showing that the H-shaped clamping element of FIG. 13 is combined with cables.

### DETAILED DESCRIPTION OF THE PREFERRED EMBODIMENT

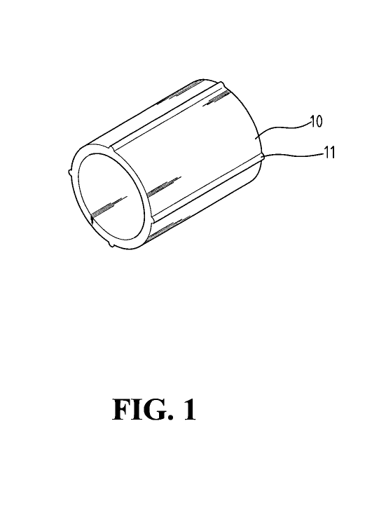

With reference to FIGS. 1-3, in accordance with the present invention, a structure for firmly combining cables with a clamping element is provided with locking ribs or locking grooves on the clamping element. The clamping element 10 can be a circular, C-shaped, 6-shaped or H-shaped section.

Referring to FIG. 1, the clamping element 10 is a tubular-like body having a circular section. An outer surface of the clamping element 10 is circumferentially provided with corresponding semi-circular locking ribs 11. The locking ribs II are straight and parallel to a central axis of the clamping element 10.

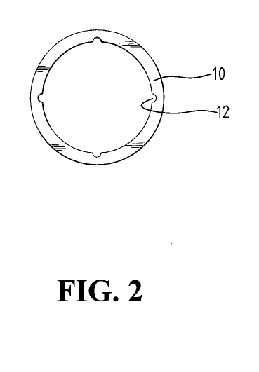

Referring to FIG. 2, the clamping element 10 is a tubular-like body having a circular section. An inner surface of the clamping element 10 is circumferentially provided with corresponding semi-circular locking grooves 12. The locking grooves 12 are straight and parallel to the central axis of the clamping element 10.

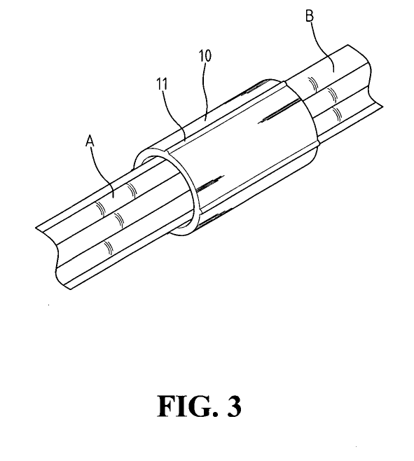

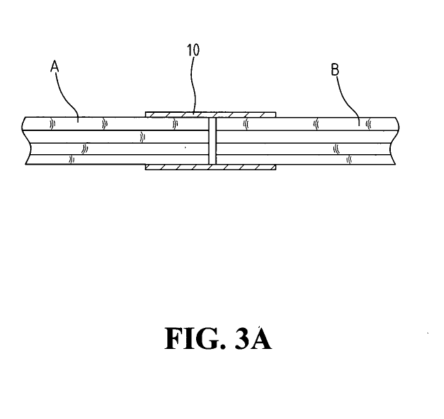

Next, with reference to FIGS. 3 and 3A, in practical application, two cables A, and B are inserted into the clamping element 10 of FIG. 1, and then a press die presses the locking ribs 11 of the clamping element 10. The compression stress on the inner surface of the clamping element 10 can be effectively reduced, thereby facilitating to firmly crimp the clamping element 10 and the two cables A, and B. As a result, the clamping element 10 can be sufficiently attached on the outer surface of the cables A, and B and kept in the shape of the cables.

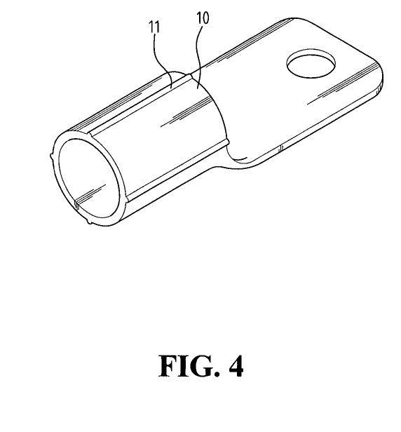

Referring to FIG. 4, the clamping element 10 has a circular section and a terminal extended from a rear portion thereof. The outer surface of the clamping element 10 is circumferentially provided with corresponding semi-circular locking ribs 11. The locking ribs 11 are straight and parallel to the central axis of the clamping element 10.

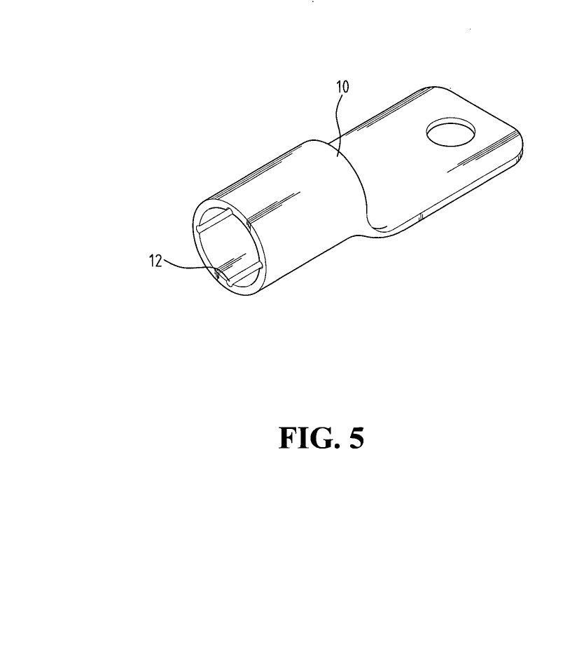

Referring to FIG. 5, the clamping element 10 has a circular section and a terminal extended from a rear portion thereof. The inner surface of the clamping element 10 is circumferentially provided with corresponding semi-circular locking grooves 12. The locking grooves 12 are straight and parallel to the central axis of the clamping element 10.

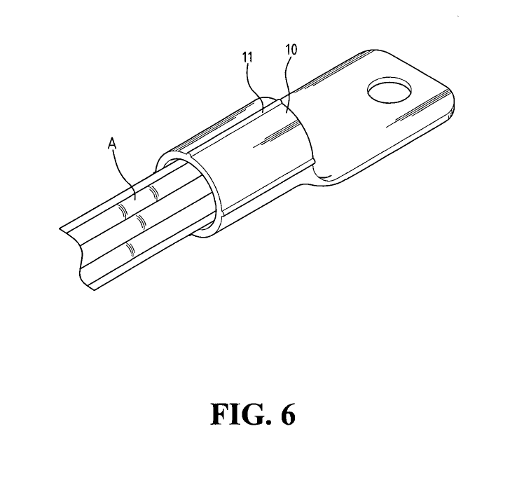

Next, with reference to FIG. 6, in practical application, a cable A is inserted into the clamping element 10 of FIG. 4, and then a press die presses the locking ribs 11 of the circular clamping element 10. The compression stress on the inner surface of the clamping element 10 can be effectively reduced, thereby facilitating to firmly crimp the clamping element 10 and the cable A. As a result, the clamping element 10 can be sufficiently attached on the outer surface of the cable A, and kept in the shape of the cable.

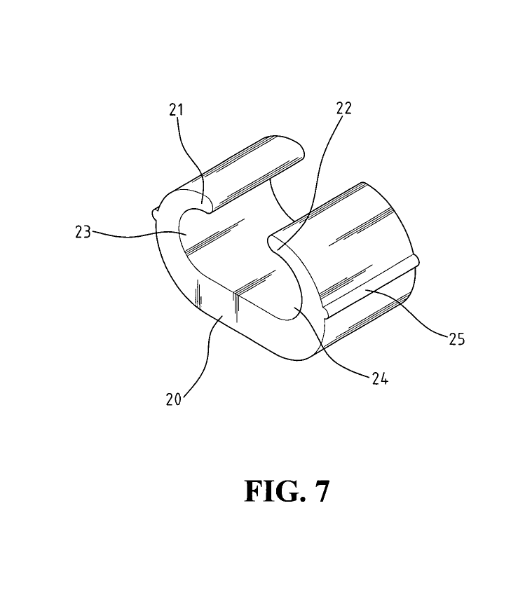

Referring to FIG. 7, a clamping element 20 in accordance with the present invention is a tubular-like body having a C-shaped section. An upper end 21 and a lower end 22 of the clamping element 20 form a first cable groove 23 and a second cable groove 24, respectively. An outer surface of the upper end 21 and lower end 22 has a semi-circular locking rib 25, respectively. The locking ribs 25 are straight and parallel to a central axis of the clamping element 20.

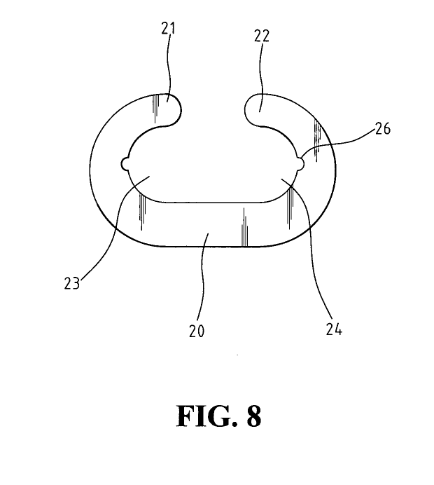

Referring to FIG. 8, the clamping element 20 is a tubular-like body having a C-shaped section. An upper end 21 and a lower end 22 of the clamping element 20 form a first cable groove 23 and a second cable groove 24, respectively. An inner surface of the upper end 21 and lower end 22 has a semi-circular locking groove 26, respectively. The locking grooves 26 are straight and parallel to the central axis of the clamping element 20.

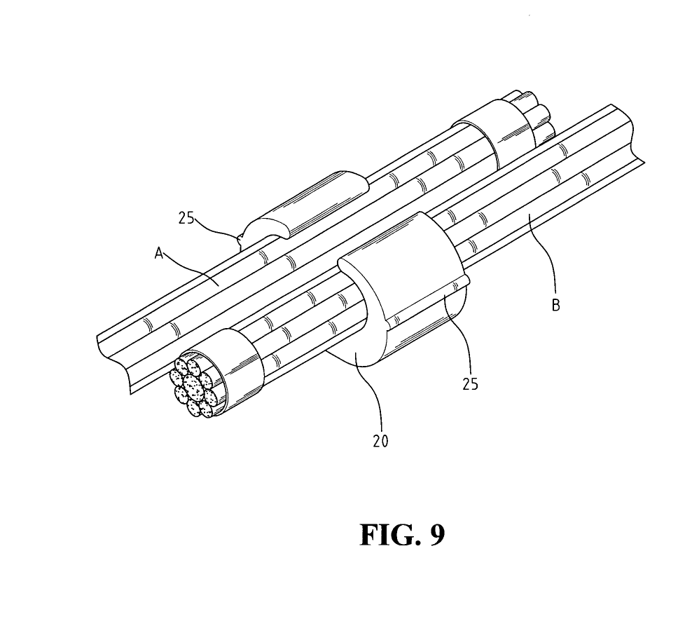

Next, with reference to FIG. 9, in practical application, two cables A, and B are inserted into the C-shaped clamping element 20 of FIG. 7, and then a press die presses the locking ribs 25 of the clamping element 20. The compression stress on the inner surfaces of the two cable grooves 23, 24 can be effectively reduced, thereby facilitating the first cable groove 23 and the second cable groove 24 to bend on the outer surface of the cables A, and B. Thus, both ends of first cable groove 23 and the second cable groove 24 abut against the cables A, and B. As a result, the cables A, and B can be firmly crimped, such that the first cable groove 23 and the second cable groove 24 can be sufficiently attached on the outer surface of the cables A, and B and kept in the shape of the cables

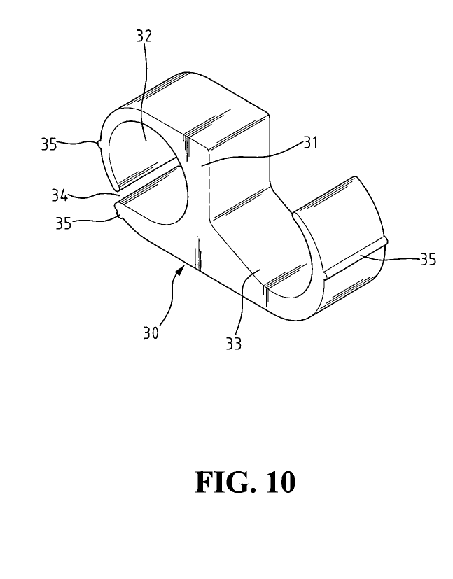

Referring to FIG. 10, a clamping element 30 in accordance with the present invention is a tubular-like body having a 6-shaped section. A partition 31 is provided in the middle of the clamping element 30. Both ends of the clamping element 30 form a first cable groove 32 and a second cable groove 33, respectively. The first cable groove 32 is of similar circular and provided with a notch 34. Near both ends of the notch 34 of the first cable groove 32, an outer surface of the clamping element 30 has two semi-circular locking ribs 35. The second cable groove 33 is of similar semi-circular. The outer surface of the second cable groove 33 of the clamping element 30 has a semi-circular locking rib 35. The locking ribs 35 are straight and parallel to a central axis of the clamping element 30.

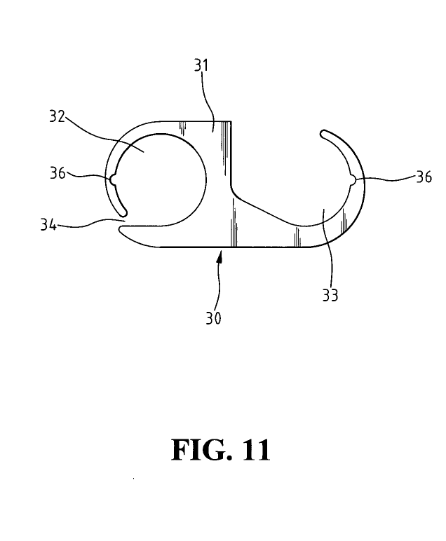

Referring to FIG. 11, the clamping element 30 is a tubular-like body having a 6-shaped section. A partition 31 is provided in the middle of the clamping element 30. Both ends of the clamping element 30 form a first cable groove 32 and a second cable groove 33, respectively. The first cable groove 32 is of similar circular and provided with a notch 34. Near one side of the notch 34 of the first cable groove 32, the inner surface of the clamping element 30 has a semi-circular locking groove 36. The second cable groove 33 is of similar semi-circular. The inner surface of the second cable groove 33 of the clamping element 30 has a semi-circular locking groove 36. The locking grooves 36 are straight and parallel to the central axis of the clamping element 30.

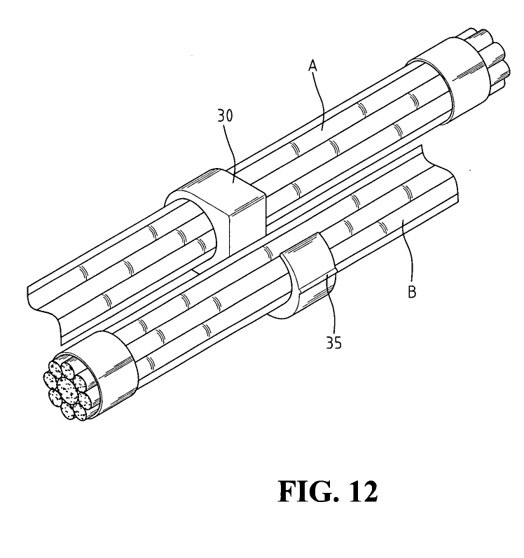

Next, with reference to FIG. 12, in practical application, two cables A, and B are inserted into the 6-shaped clamping element 30 of FIG. 10, and then a press die presses the locking ribs 35 of the clamping element 30. The compression stress on the inner surfaces of two cable grooves 32, 33 can be effectively reduced, thereby facilitating the first cable groove 32 and the second cable groove 33 to bend on the outer surface of the cables A, and B. Thus, both ends of first cable groove 32 and the second cable groove 33 abut against the cables A, and B. As a result, the cables A, and B can be firmly crimped, such that the first cable groove 32 and the second cable groove 33 can be sufficiently attached on the outer surface of the cables A, and B and kept in the shape of the cables.

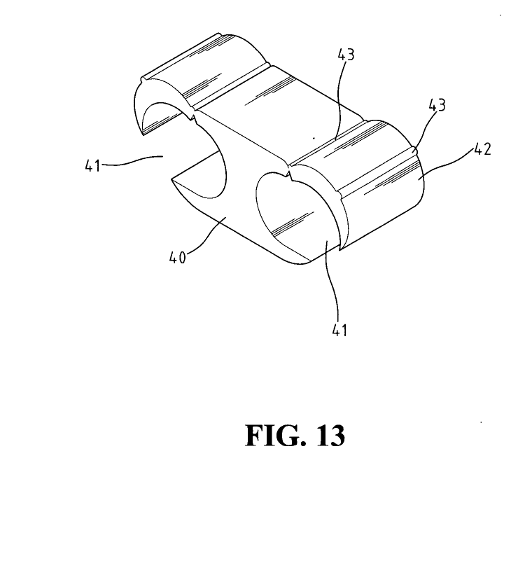

Referring to FIG. 13, the clamping element 40 is a tubular-like body having a H-shaped section. Each end of the clamping element 40 forms a cable groove 41 with symmetry in vertical direction. An upper end of the cable groove 41 is connected with a cap 42, and an outside middle surface of the cap 42 is provided with a semi-circular locking rib 43. The H-shaped clamping element 40 has another semi-circular locking rib 43 on the connection between the upper end of each of the cable grooves 41 and its corresponding cap 42.

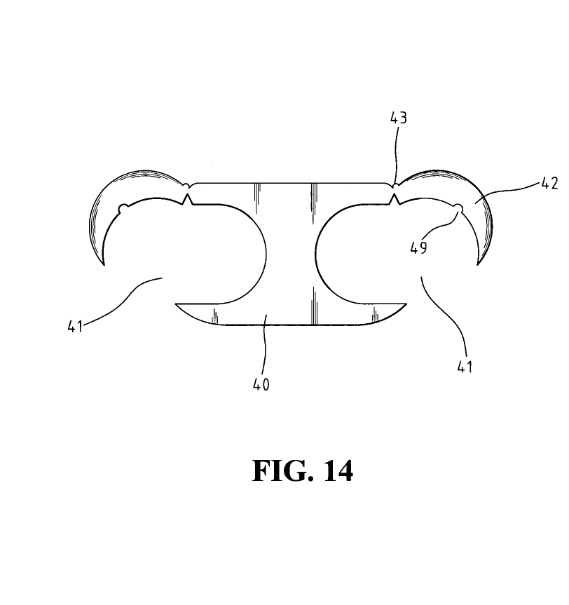

Referring to FIG. 14, the clamping element 40 is a tubular-like body having a H-shaped section. Each end of the clamping element 40 forms a cable groove 41 with symmetry in vertical direction. An upper end of the cable groove 41 is connected with a cap 42, and an inside middle surface of the cap 42 is provided with a semi-circular locking groove 49. The H-shaped clamping element 40 has a semi-circular locking rib 43 on the connection between the upper end of each of the cable grooves 41 and its corresponding the cap 42.

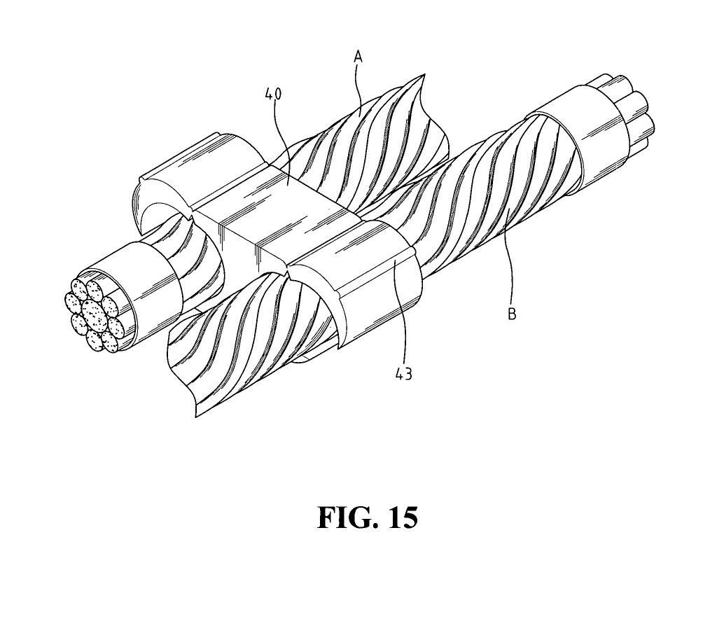

Next, with reference to FIG. 15, in practical application, two cables A, and B are inserted into the H-shaped clamping element 40 of FIG. 13, and then a press die presses the locking ribs 43 of the clamping element 40. The cables A, and B can be fixed in the clamping element 40. Further, the locking rib 43 formed on the connection between the upper end of the cable groove 41 and the cap 42 can enhance the strength of the cap 42, such that it cannot break at the connection of the clamping element 40. As a result, the cables A, and B can be firmly crimped, such that the clamping element 40 can be sufficiently attached on the outer surface of the cables A, and B and kept in the shape of the cables.

Although the present invention has been described with reference to the preferred embodiment thereof, it is apparent to those skilled in the art that a variety of modifications and changes may be made without departing from the scope of the present invention which is intended to be defined by the appended claims.

1. A structure for firmly combining cables with a clamping element, the clamping element being of tubular-like shape having a circular inner surface without indented areas or grooves and an outer surface formed with locking ribs.

2. The structure for firmly combining cables with a clamping element according to claim 1, wherein the clamping element has a circular section.

3. The structure for firmly combining cables with a clamping element according to claim 1, wherein the clamping element has a circular section and a terminal integrally formed on and extended from a rear portion thereof.

4. The structure for firmly combining cables with a clamping element according to claim 1, wherein the clamping element has a C-shaped section.

5. The structure for firmly combining cables with a clamping element according to claim 1, wherein the clamping element has a 6-shaped section.

6. The structure for firmly combining cables with a clamping element according to claim 1, wherein the clamping element has a H-shaped section.

7. The structure for firmly combining cables with a clamping element according to claim 1, wherein the locking ribs are straight and parallel to a central axis of the clamping element.

8. A structure for firmly combining cables with a clamping element, the clamping element being of tubular-like shape having a circular outer surface without protruded areas or ribs and an inner surface formed with locking grooves.

9. The structure for firmly combining cables with a clamping element according to claim 8, wherein the clamping element has a circular section.

10. The structure for firmly combining cables with a clamping element according to claim 8, wherein the clamping element has a circular section and a terminal integrally formed on and extended from a rear portion thereof.

11. The structure for firmly combining cables with a clamping element according to claim 8, wherein the clamping element has a C-shaped section.

12. The structure for firmly combining cables with a clamping element according to claim 8, wherein the clamping element has a 6-shaped section.

13. The structure for firmly combining cables with a clamping element according to claim 8, wherein the clamping element has a H-shaped section.

14. The structure for firmly combining cables with a clamping element according to claim 8, wherein the locking grooves are straight and parallel to a central axis of the clamping element.
